(19) United States
(12) Patent Application Publication
(10) Pub. No.: US 2017/0132695 A1
(43) Pub. Date: May 11, 2017

(54) SCALABLE SYSTEM OF DISTRIBUTED COMPUTING DEVICES TO CALCULATE QUOTES ACROSS MULTIPLE PLATFORMS

(71) Applicant: HomeAway, Inc., Austin, TX (US)

(72) Inventors: Charles V. Shannon, JR., Centennial, CO (US); David Brown, Denver, CO (US); Brian Reishel, Austin, TX (US)

(73) Assignee: HomeAway, Inc., Austin, TX (US)

(21) Appl. No.: 14/935,229

(22) Filed: Nov. 6, 2015

(51) Int. Cl. G06Q 30/06; G06Q 10/02

(52) U.S. Cl. CPC G06Q 30/0645; G06Q 10/02; G06Q 30/0611

(57) ABSTRACT

Various embodiments relate generally to electrical and electronic hardware, computer software and systems, and wired and wireless network communications for calculating quotes for items via a distributed computing system. In particular, a system and a method may be configured to generate customized quotes for items, such as rental properties, in an efficient manner using aggregator and quoter computing devices. In some examples, a method includes receiving at aggregator computing devices a request, determining a subset of quoter computing devices as a function of a subset of the rental property unit identifiers, identifying a rate algorithm type, accessing an in-memory cache to retrieve data representing a rate algorithm and/or rate algorithm data, calculating one or more rate data components, and aggregating the rate data components to form an aggregated data structure as a response. A method may also cause presentation of a graphically-formatted representation of the response.

### FIELD

Various embodiments relate generally to electrical and electronic hardware, computer software and systems, and wired and wireless network communications for calculating quotes for items via a distributed computing system. In particular, a system and a method may be configured to generate customized quotes for items, such as rental properties, in an efficient manner using aggregator computing devices and quoter computing devices.

### BACKGROUND

There exists a variety of conventional implementations to establish computerized marketplaces, such as networked vacation rental marketplaces. Although functional, such computerized marketplaces typically have a number of drawbacks including relatively rigid requirements for searching online product offerings and trying to determine pricing of such product offerings. To illustrate, consider a vacation rental marketplace in which disparate owners of second or vacation homes have experienced increasing growth recently. In a vacation rental marketplace, a family or a group of people (e.g., group of friends) may rent anything from cabins, condominiums, summer homes, to villas, barns, farm houses, and castles. These types of rental properties are desirable as typical hotel or motel buildings are not well-suited to accommodate families or groups of people, and are usually less private and less comforting to some guests.

With the advent of networked computing devices, the computer-based renting of properties electronically has enabled travelers to more readily enjoy the experiences of renting others' homes. But while some conventional technological approaches to searching electronic listings of renting properties via computer networks are functional, these approaches are suboptimal in determining accurate pricing information quickly to enhance the searching process.

As such, common approaches to searching and determining pricing information for rental properties may be perceived as being relatively costly or slow in identifying and presenting property listings to a potential traveler. Further, sophisticated rate structures for determining pricing of rental properties, which is typically entered manually by a property manager, typically is composed of complex components, such as “add-on” items, taxes, qualified discounts (e.g., AARP™, AAA™, etc.), and the like.

Thus, what is needed is a solution for facilitating accurate quotes of vacation rental properties, or other product items, without the limitations of conventional techniques.

### BRIEF DESCRIPTION OF THE DRAWINGS

Various embodiments or examples (“examples”) of the invention are disclosed in the following detailed description and the accompanying drawings:

FIG. 1 is a diagram depicting a rate calculation system, according to some embodiments;

FIG. 2 is a diagram depicting a rate calculation system implementing various computing devices, according to some embodiments;

FIG. 3 is a diagram depicting an architecture for a rate calculation system implementing note clusters, according to some examples;

FIG. 4 is a diagram depicting a quote service accessing in-memory cache in accordance with various examples;

FIG. 5 is an example of a flow diagram to preform rate calculations, according to some embodiments;

FIG. 6 is a diagram depicting another rate calculation system, according to some embodiments;

FIG. 7 is an example of a flow diagram to preform dynamic rate calculations, according to some embodiments; and

FIG. 8 illustrates an exemplary computing platform disposed in a computing system configured to calculate rates for items, such as rental properties, according to various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

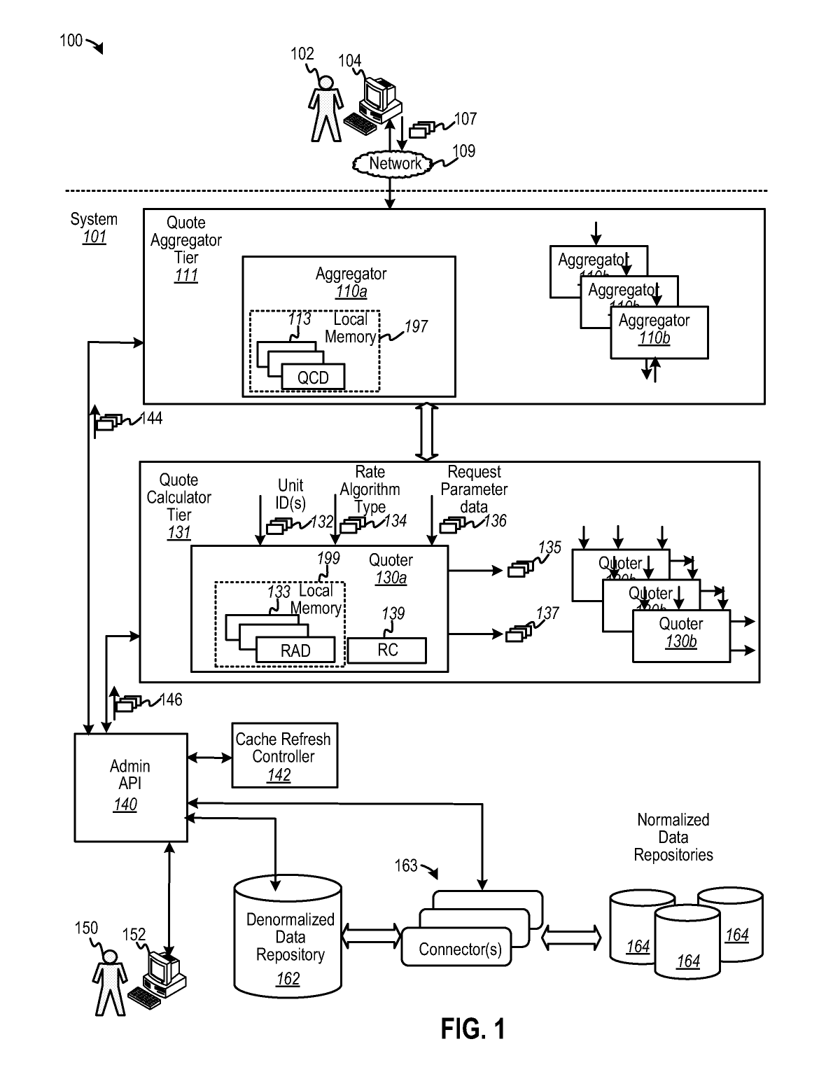

FIG. 1 is a diagram depicting a rate calculation system, according to some embodiments. Diagram 100 includes a rate calculation system 101 including a tier 111 (“quote aggregator tier”) of aggregator computing devices 110 and a tier 131 (“quote calculator tier”) of quoter computing devices 130, whereby rate calculation system 101 is configured to access rate data instantaneously (or nearly instantaneously) for large numbers of properties subject to a search query. Aggregator computing devices tier of 111 are configured to facilitate top-level parallelization of rate calculations. Tier 111 of aggregator computing devices is shown to include one or more aggregators 110a and 110b, each of which include one or more processors and memory and is configured to receive data 107 representing a request via network 109 from a requester computing device 104 associated with a requester 102 (e.g., a traveler or potential renter).

In some cases, request data 107 may include rental property unit identifiers and one or more request parameters, such as an arrival date (a start date), a check-out date (an end date), a number of occupants, and the like. For example, request data 107 may cause one or more aggregators 110 to generate quote requests for many properties (e.g., associated with 10,000 property identifiers or more) in an instance (e.g., in a single instance). As shown, aggregators 110a and 110b include quoter configuration data (“QCD”) 113, which includes data representing configuration states of one or more quoters 130a in tier 131 of quoter computing devices. Based on quoter configuration data 113, aggregators 110a and 110b are configured to determine a subset of quoters 130a and 130b in tier 131 of quoter computing devices as a function of at least a subset of rental property unit identifiers that each uniquely identify a rental property subject to a search. Quoter configuration data 113 is configured to identify which quoter of quoters 130a and 130b is capable of calculating a portion of a quote. In some examples, quoter configuration data 113 may be used to identify a quoter computing device that is associated with a rate algorithm type to perform a rate calculation based on, for example, at least a rental property unit identifier. According to some examples, an aggregator 110 may receive a quote request in a variety of forms or formats (e.g., a single quote request may return a result of relatively high verbosity, whereas a batch quote request may return a result of medium or low verbosity). Therefore, an aggregator 110 may partition a quote request (e.g., a batch quote request) into multiple internal quote requests, each directed to a quote service node (e.g., at least one of quoters 130a and 130b) capable of calculating the rates for its constituent piece of the original request. The results of various internal sub-requests are then aggregated at tier 111 for transmission to requesting computer device 104, which may be the original caller.

Further, one or more of aggregator 110a and aggregators 110b may partition a request into a number of sub-requests, each of which may be provided to a specific quoter in quoters 130a and 130b for purposes of implementing a specific rate calculation algorithm. Aggregators 110a and 110b further are configured to receive results from quoters 130 and to aggregate one or more rate data components to form an aggregated data structure with which to generate data representing a response to the request. Aggregators 110a and 110b may also be configured to generate data representing the response to the request to include data configured to cause presentation of a graphically-formatted representation of the response at requester computing device 104. For example, the response may include portions of a user interface that is subdivided into property listings, each portion displaying information about a particular property including rate information based on request parameter data. Accordingly, aggregators 110a and 110b are configured to aggregate any number of rate data components generated by tier 131 of quoter computing devices, as well as aggregate rate-related information (e.g., based on the rate data components) with other property listing information to form a response to requester computing device 104. Examples of other property listing information includes a property type (e.g., an apartment, a barn, a cabin, a condominium, a home, a villa, etc.), a location type (e.g., adjacent to the beach, a downtown area, a lake, a mountain, an ocean, a river, etc.), features (e.g., air-conditioning, a fireplace, a hot tub, Internet access, etc.). The other property listing information may be accessed by aggregators 110 from a repository not shown in diagram 100. Examples of rate data components may include a portion of a rate, whereby each rate portion is derived in accordance with a particular rate algorithm or rate structure, such as rate portions derived from tax rates, additional fees, seasonality, numbers of occupants, qualified discounts, or any other rate adjustments, according to at least some embodiments.

Each of quoters 130a and 130b may include a rate calculator 139, which may be configured to operate as a rate calculation engine to calculate a rate data component in accordance with a rate algorithm type. A quoter, such as quoter 130a, which is identified by an aggregator 110 to perform rate calculations may be configured to receive rental property unit identifier data (“Unit IDs”) 132, rate algorithm type data 134, request parameter data 136 (e.g., arrival date, check-out date, number of occupants etc.), and the like. Rental property unit identifier data 132 may be implemented as an alpha-numeric value that uniquely identifies a rental property. Rate algorithm type data 134 includes data configured to identify a type of rate algorithm to be applied to rate algorithm data (“RAD”) 133 stored locally in the quoter. Examples of rate algorithm types include data representing identifiers for implementing EscapiaVRS™, V12.NET™, Quotable Rates, Structured Rates, etc., each of which is provided by HomeAway, Inc., of Austin, Tex., as well as any other rate structures or algorithms.

In operation, quoter 130a and/or any of its components, such as rate calculator 139, may be configured to access local memory to retrieve data representing rate algorithm data (“RAD”) 133 associated with a rate algorithm type indicated by rate algorithm type data 134. According to some embodiments, the local memory can be implemented as an in-memory cache 199 of a quoter computing device 130a. In-memory cache 199 may include local RAM internal to, or associated with, quoter 130a or a processor therein. In some cases, in-memory cache 199 may include RAM in a subset of the one or more quoter computing devices or processors therein. Quoter 130a may access the in-memory cache by, for example, applying address data to the in-memory cache 199, wherein a processor associated with the quoter computing device applies the address data as an abbreviated form (e.g., in compressed form, such as a specialized key) to identify the rental property unit. According to some embodiments, rate algorithm data 133 is stored in data arrangements that promote increased data access speeds (e.g., in real-time or near real-time), and horizontal scaling of nodal computing devices, etc. In at least some examples, rate algorithm data 133 is stored in a denormalized data arrangement within in-memory cache 199. Quoters 130a and 130b may be configured to calculate one or more rate data components 135 based on one or more request parameters and an associated rate algorithm (e.g., as identified by a rate algorithm type), whereby rate data components 135 may be returned to an aggregator 110 that initially called one or more quoters 130.

Diagram 100 depicts system 101 further including an administration application programming interface (“Admin API”) 140, a cache refresh controller 142, a denormalized data repository 162, one or more connectors 163, and one or more normalized data repositories 164, one or more of which are communicatively coupled together. Connectors 163 may be configured to acquire rate data from various systems of record sources, such as data stored in normalized data repositories, and transform that rate data into a denormalized data arrangement, according to some examples. To illustrate, consider the following example for forming denormalized rate document stored in denormalized data repository 162. Connectors 163 (e.g., connector services implemented in one or more computing devices) may be configured to collapse rate information stored in multiple tables of normalized data repositories 164 into, for example, a single schema, whereby one document (or row) per item is disposed in denormalized data repository 162 as a flattened Cartesian cross-product. As such, the document may include information for calculating a monthly rate for a unit associated with unit identifier data 132 of “PropertyID:1002562” during season (1) one (e.g., January 1 to June 30) in the context of booking a rental online by a particular customer (e.g., requester 102). The data in this example may originate from seven (7) different tables (or more) in normalized SQL server databases associated with, for example, different entities hosting different properties (e.g., via databases that link property information and rental availability to various sales distribution channels or partnerships of computing networks and devices, such as via ISILink® of HomeAway, Inc.).

Cache refresh controller 142 is configured to coordinate rate data cache refreshes of rate algorithm data (“RAD”) 133 stored in in-memory cache 199 to ensure accurate rate algorithms and rate data are available and up-to-date to compute rate quotes of various degrees of complexity for any number of property listing searches. Cache refresh controller 142 can implement a cache invalidation algorithm to refresh cache(s) 199 with updates or changes to rate algorithm data 133. For example, a property manager may modify rental prices or rate structures associated with one or more rental units/property listings. The modified rental prices in rate structures may be propagated as updates into normalized data repositories 164. One or more connectors 163 detect a change to normalized data repositories 164, and may cause an update to denormalized data repository 162 to capture the change. Further, cache refresh controller 142 may detect that an update is available and generate a cache invalidation message 146 to cause rate algorithm data 133 stored within in-memory cache 199 to be updated over one or more quoters 130a and 130b. In some examples, quoter 130a may transmit cache refresh message 137 to other quoters 130b. Similarly, the cache invalidation algorithm may be implemented by cache refresh controller 142 in which cache(s) 197 that include quoter configuration data 113 are refreshed to reflect an update or changes to which quoters 130a and 130b are to be used for corresponding types of requests by aggregators 110a and 110b. For example, when a configuration is changed, affected aggregators 110a and 110b may receive a cache invalidation message 144 so that cache memories 197 of aggregators 110a and 110b can be updated.

Cache refresh controller 142 may be responsive to any change in rate data so as to implement an updating scheme whereby relevant nodes (e.g., aggregators 110 and/or quoters 130) are alerted to an impending update in a way that minimally or negligibly affects on-going calculations. Therefore, affected aggregators 110a and 110b or quoters 130a and 130b can update their corresponding caches with updated data without causing downtime (or with negligible effects on the operability of aggregators 110a and 110b or quoters 130a and 130b, at least as perceived by requesters 102). Accordingly, system 101 provides that rate data can be updated or moved into a cache without affecting operation or causing downtime. Aggregators 110a and 110b or quoters 130a and 130b are configured to “listen” continuously for updates, which may include updated data that can be applied relatively quickly. In some cases, there may be a few millisecond interval, or less, in which some aggregators 110 and/or quoters 130 have the old data and some aggregators 110 and/or quoters 130 have the new data. Note, however, this disparity is negligible and is minimally perceived (or is not perceived) by requesters 102 via requesting computing devices 104.

Administration API 140 is configured to provide a service that allows administrators 150 to manage and configure via administration computing device 152 one or more structures and/or functions of system 101. According to some examples, administration API 140 may be configured to program or otherwise adjust the coordination of cache refreshes among various aggregators 110 and quoters 130, or corresponding APIs. Administration API 140 may be configured to allow administrators 150 to insert, update and delete information, such as quoter configuration data 113 about quoters 130 in system 101. For example, administration API 140 can provide configuration update messages 144 to identify a subset of quoters 130a and 130b (e.g., a set of inventory slices) that are available to service requests and sub-requests from tier 111 of aggregator computing devices. Also, administration API 140 may be configured to allow administrators 150 to update and delete information about how rate algorithm types should be applied or otherwise implemented among configured quoters 130. Further, administration API 140 may enable administrators 150 to queue up messages in cache refresh controller 142, which, in turn, may configure rate data stored in caches 199 of system 101 and its components that are to be refreshed (i.e., with denormalized data repository 162). Note that the above-described functions of administration API 140 are not intended to be limiting, and administration API 140 may be configured to perform other actions or functions, too.

In view of the foregoing, the structures and/or functionalities of rate calculation system 101 and its components can perform numerous rate quotes for a large number of property listing queries. According to some embodiments, rate calculation system 101 may be implemented as a distributed, horizontally scalable, self-balancing rate calculation engine capable of computing at least 750,000 quotes per second, or greater, whereby the quotes are accurate to at least two decimal places (i.e., “to the penny”). Each service tier is horizontally scalable to allow for massive throughputs, and can be grown on demand as data traffic and/or inventory increases over time. In some instances, tier 111 of aggregator computing devices and tier 131 of quoter computing devices may each scale horizontally independently and at different rates. Some components of system 101, such as cache refresh controller 142, are configured to effect communication between nodes of aggregator and/or quoter computing devices, and to coordinate cache updates. Further, connectors 163 may be configured to synchronize data via cache refreshes in denormalized data repository 162 (e.g., denormalized rate data) with various end-system systems of record, such as normalized data repositories 164. A subset of one or more quoters 130 may be configured to handle rate calculations for a set of inventory slices that can include, for example, a relatively large set of Rate Algorithm Data (“RAD”) representing some subset of a total quotable inventory of system 101. System 101 may manage an inventory of computing devices that can be divided in any way. For, instance, any one inventory slice may be configured on at least three different quoter nodes for enhanced availability. This also makes it possible to execute cache refreshes without any service down time (or minimal down time) and minimal performance degradation. Rate data for the above-described inventory slices may be stored in RAM of quoters 130 to reduce or negate latency access during rate calculations. A combination of in-memory caches 199 and denormalized rate data facilitates rapid rate calculations, according to some embodiments. In some embodiments, a rate calculation is performed at O(1) to maximize the speed of individual calculations, whereby the parallelization of these calculations across available computing devices (e.g., hardware threads) provides for an enhanced performance boost.

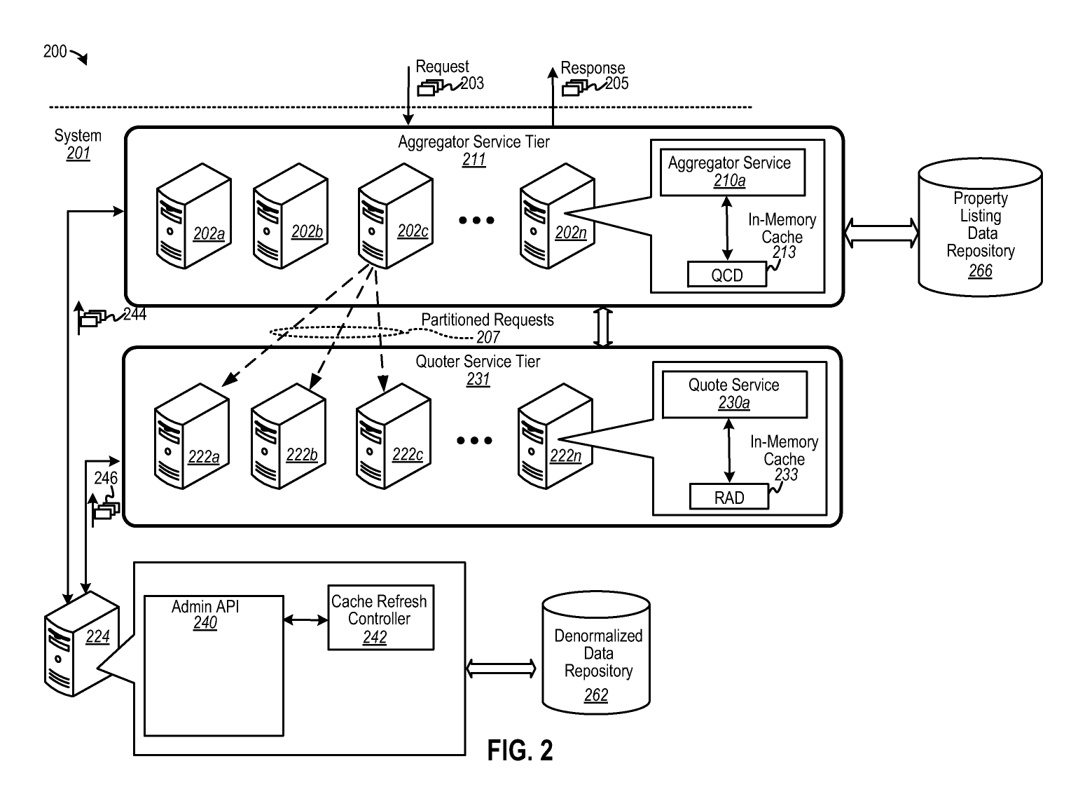

FIG. 2 is a diagram depicting a rate calculation system implementing various computing devices, according to some embodiments. Diagram 200 includes an aggregator service tier 211 including any number of aggregator computing devices 202a to 202n, one or more of which include applications or other executable instructions to implement an aggregator service 210a communicatively coupled to an in-memory cache 213 that is configured to store quoter configuration data (“QCD”). In some cases, aggregator computing devices 202a to 202n may access property listing data repository 266 to access other data components that may be used to form a property listing, whereby rate components calculated by quoter service tier 231 can be aggregated with other property listing data, such as pictures and various portions of text describing features and characteristics of one or more units. Diagram 200 also includes a quoter service tier 231 including any number of quoter computing devices 222a to 222n, one or more of which include applications or other executable instructions to implement a quoter service 230a communicatively coupled to an in-memory cache 233 that is configured to store rate algorithm data (“RAD”). Further to diagram 200, rate calculation system 201 includes an administrative computing device 224, which may include an administrative API 240 and a cache refresh controller 242, both of which may access denormalized data in a denormalized data repository 262. Cache refresh controller 242 may be configured to generate cache refresh messages 244 and 246 for refreshing in-memory caches 213 and 233, respectively. Note that elements depicted in diagram 200 of FIG. 2 may include structures and/or functions as similarly-named or similarly-numbered elements depicted in other drawings.

According to some examples, cache refresh controller 242 may determine a rate algorithm data has changed, and may transmit data representing an updated rate algorithm data (e.g., as cache refresh message 246) to a group of in-memory caches 233 associated with a subset of quoter computing devices 222. Updating the group of in-memory caches 233 may include updating rate algorithm data using a denormalized data arrangement. Note that the updating of a group of in-memory caches 233 may be responsive to detecting a cache refresh message 246. One or more connectors (not shown) may be configured to access sources of normalized data (not shown) stored in one or more normalized databases. These databases can include rate data formatted in a normalized data arrangement, whereby the connectors can operate to transform the rate data into a denormalized data arrangement format from the normalized data arrangement format. The denormalized data arrangement may be stored as rate data in denormalized database 262.

An aggregator computing device 202 may operate to partition data associated with a request into sub-requests 207 and transmit each of the sub-requests to a corresponding quoter computing device 222a to 222c as indicated in the quoter configuration data. In various examples, partitioning the data associated with the request into the sub-requests can include partitioning the data based on one or more of different rate algorithm types, different shards, different sub-request types, and the like.

Further to FIG. 2, an aggregator computing device 202 may receive data representing a start date, an end date, and a number of occupants as the one or more request parameters, whereby aggregator computing device 202 operates to access quoter configuration data, or QCD, stored in one or more caches in the one or more aggregator computing devices 202. When accessing quoter configuration data, an aggregator service 210a may be configured to match address data against another portion of in-memory cache associated with aggregator computing device 202 to retrieve the quoter configuration data specifying a subset of quoter computing devices 222 that may be used to perform the rate calculations. According to some embodiments, subsets of quoter computing devices 222 may be implemented as “shards” to ensure that for any slice of inventory there is at least, for example, two to four (or more) quoter services 230a available to perform rate quote calculations in accordance with the various examples described herein. Data sharding may cause data to be spread across multiple nodes of quoter services. As such, any particular quoter node may be taken off-line to refresh its cache or update a configuration without affecting rate calculations performed by other nodes.

According to some embodiments, aggregator computing device 202 can provide different types of requests to one or more quoter computing devices 222. In some examples, requests for rate quotes 203 and responses 205 may be provided to system 201 and/or aggregator service tier 211, according to various examples. An aggregator computing device 202c can partition a request into a number of sub-requests 207 based on, for example, a type or class of a request. In various examples, a request may be a low verbosity quote, a medium verbosity quote, or a high verbosity quote, as well as any other intermediate levels of verbosity quotes. Low verbosity quotes can include data representing dollar amounts, details of the rate, taxes, and fees. Medium verbosity quotes can include data that shows also human readable descriptions of each of the line item charges. High verbosity quotes can include a large superset of information, including property identifiers or description, cancellation policy text, itemized charges and taxes, etc., and are more detailed than quotes of lower levels of verbosity. They are generally scoped to a single property and need not be used for large batch quoting requests. By contrast, consider that low verbosity quotes may include a request for rates for hundreds or thousands of properties to be quoted quickly, perhaps for filtering or sorting a result set by price. Examples of a low verbosity request and response are as follows (note that order need not be preserved as the result may be aggregated from any number of parallel calls).

LOW_VERBOSITY_QUOTE_REQUEST (JSON)

“PropertyUUIDs”:[
“00000000-0000-0000-0000-000000000000”,
...,
“00000000-0000-0000-0000-000000000012”,
“00000000-0000-0000-0000-000000000013”,
“QuoteAsOf”:“20XX-01-15”, “ArrivalDate”:“20XX-01-16”,
“DepartureDate”:“20XX-01-23”, “Adults”:2,“Children”:2, “Pets”:false,
“ReservationType”:“”, “RateAdjustmentCategory”:“”

LOW_VERBOSITY_QUOTE_RESPONSE (JSON)

```
[
  {
    “Rate”:70.0, “Currency”:“TWD”,
    “PropertyUUID”:“00000000-0000-0000-0000-000000000012”
  },
  ...
  {
    “Rate”:70.0, “Currency”:“GBP”,
    “PropertyUUID”:“00000000-0000-0000-0000-000000000013”
  },
  {
    “Rate”:70.0, “Currency”:“JPY”,
    “PropertyUUID”:“00000000-0000-0000-0000-000000000000”
  }
]
```

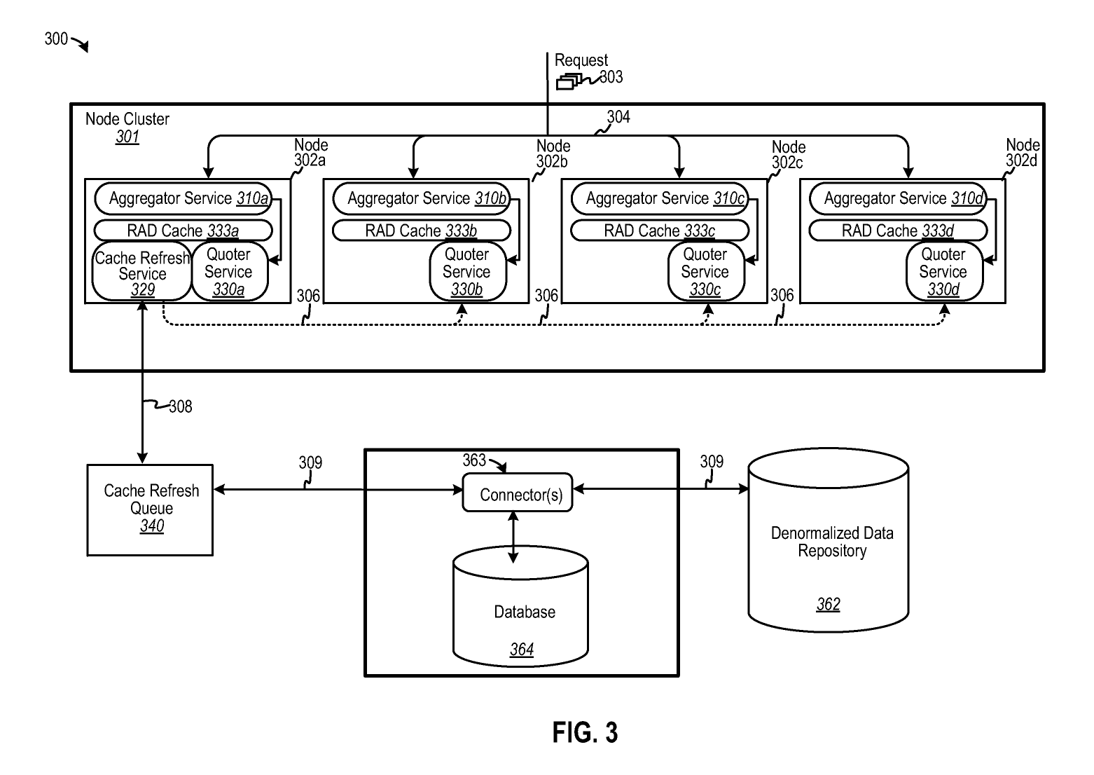

FIG. 3 is a diagram depicting an architecture for a rate calculation system implementing note clusters, according to some examples. Diagram 300 includes a node cluster 301 including any number of nodes 302a to 302d. Each node 302 is shown to include an aggregator service 310 configured to perform aggregator functions, as described herein, a rate algorithm data cache 333 for storing denormalized rate data, and a quoter service 330 configured to perform rate quotes. An aggregator service 310 may receive a request 303 via one of paths 304. For example, aggregator service 310b may receive a request for a quote and generate a request to one or more quoter services 330a-d to calculate a rate quote. Diagram 300 further shows a cache refresh queue 340 coupled via paths 309 to one or more connectors 363, which, in turn, are configured to synchronize denormalized data in denormalized data repository 362 with data stored in a normalized database 364. Note that elements depicted in diagram 300 of FIG. 3 may include structures and/or functions as similarly-named or similarly-numbered elements depicted in other drawings.

According to some examples, a connector 363 is configured as a system of record (“SOR”) connector that may be configured to synchronize denormalized data in repository 362 with normalized data within database 364. In some cases, denormalized data repository 362 may implement a no-SQL database, such as MongoDB™ Connector 363 may be configured to listen to a message exchange (e.g., RabbitMQ™ exchange) for relevant refresh messages, and may refresh denormalized data repository 362 with any relevant data updates. Connector 363 may also provide updated rate data in a message via RabbitMQ to cache refresh queue 340, which, in turn, may be implemented by cache refresh service 329 (and via paths 306 to other nodes/caches). Cache refresh service 329 is configured to acquire connector messages, extract the relevant data from denormalized data repository 362, and publish messages to targeted quoter services 330 and aggregator services 310 with updated data.

Cache refresh service 329 may be implemented as a cache refresh controller (as described herein), and may operate as a Windows® service (daemon) that coordinates rate data cache refreshes among quoter service nodes 330 and aggregator service nodes 310. Cache refresh messages may be transmitted via path 308 and target only specific nodes undergoing updates so that unaffected quote service nodes and aggregator service nodes need not be affected. According to some instances, aggregators receive a unit identifier and a rate algorithm type via path 308 to be updated. Quoters may receive via path 308 a unit identifier, a rate plan, and unit availability data for updating rate algorithm data in in-memory caches 333.

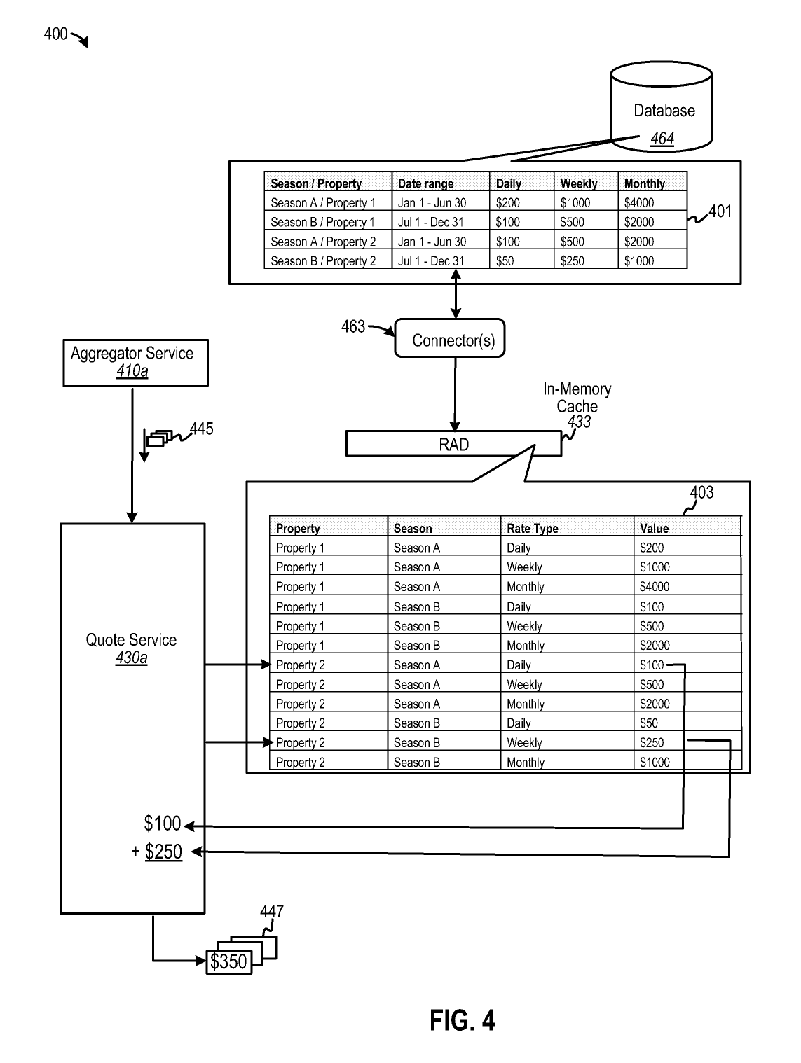

FIG. 4 is a diagram depicting a quote service accessing in-memory cache in accordance with various examples. Diagram 400 depicts a database 464 configured to store normalized data arrangements 401, a connector 463 configured to provide denormalized data, such as denormalized rate algorithm data (“RAD”), to in-memory cache 433. In-memory cache 433 stores rate algorithm data in a denormalized data arrangement 403, which is accessible by quote service 430a in servicing a quote request 445 from aggregator service 410a. Note that elements depicted in diagram 400 of FIG. 4 may include structures and/or functions as similarly-named or similarly-numbered elements depicted in other drawings.

To illustrate the example shown in diagram 400, consider an example in which quote service 430a receives request data 445 including data describing a number of adults, a number of children, check-in and checkout dates, and a dictionary of a rate algorithm type associated with an array of unit IDs (e.g., property identifiers). Aggregator service 410a thereby requests that quote service 430a calculate a rate for this particular rate type for these units, and may also request a second rate type for a second group of units, and a third rate type for a third group of units, etc. There may be any number of different rate structures that may be implemented by quote service 430a. According to some examples, a rate algorithm type may be described as a rate structure/algorithm that is used to calculate a quote given a unit's rate structure (i.e., a rate structure assigned to the unit). Quote service 430a can further operate to spin up multiple threads to further parallelize the computation to take advantage of multiple processor cores on the machine (e.g., 16 core machine can provide 16 calculations in parallel to reduce latency), according to some examples.

Further to the above-described example, consider that denormalized data arrangement 403 is implemented as a flattened Cartesian product that can be stored in memory 433 (e.g., as a dictionary or specialized hash table, or as any other data structure). As such, denormalized data arrangement 403 provides for O(1) access times for quote service 430a to retrieve parameters for a rate algorithm. Also, note that normalized data arrangement 401 collapses the “season” and “property” axes into a single axis for purposes of this example. Note further that property 1 is twice as expensive as property 2, and season A is twice as expensive as season B. Next, consider that a rate algorithm implemented in quote service 430a takes as its inputs a start date, an end date, and a property identifier. For example, consider that a traveler wishes to stay from June 30 to July 7 at property 2 (i.e., one day (June 30^{th}) at a daily rate in season A, and a week (July 1^{st} to July 7^{th}) at a weekly rate in season B.). Thus, in-memory rate data dictionary 403 can be accessed by quote service 430a via a key composed of the tuple (e.g., property, season, rate type) to achieve O(1) look-up for two values in the rate computation. As shown, the following values of $100 and $250 are returned relatively quickly to calculate a rate of $350, which is transmitted as a rate data component 447 to aggregator service 410a. Note that other more complex implementations of denormalized data arrangement 403 and one or more quote services 430 may be implemented to extend to any arbitrarily complex n-dimensional data sets, according to various examples.

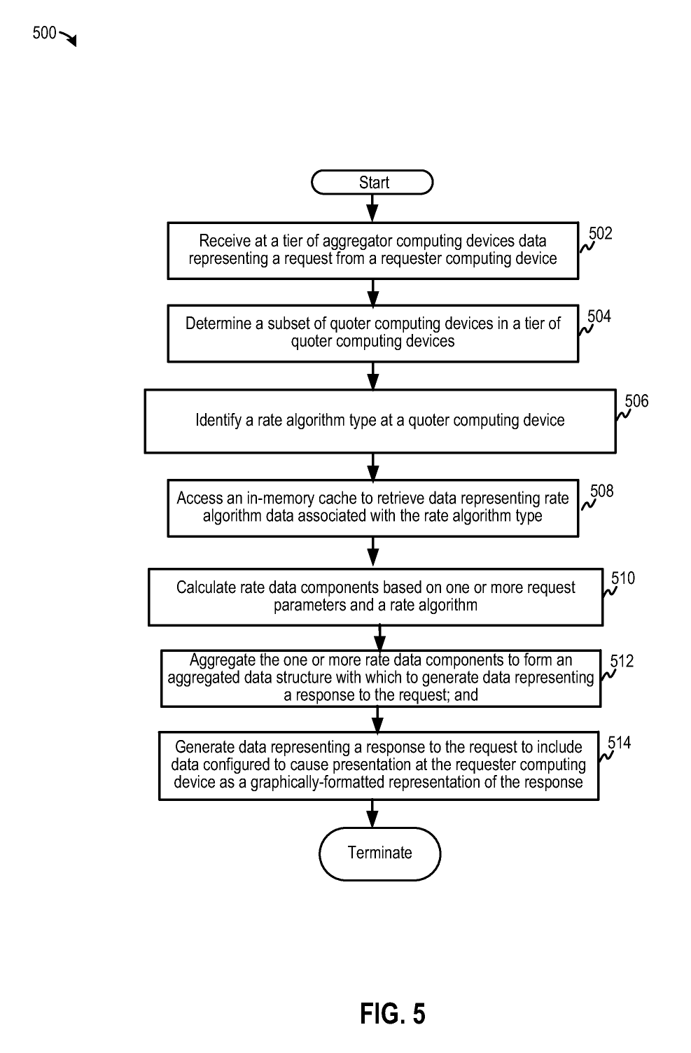

FIG. 5 is an example of a flow diagram to preform rate calculations, according to some embodiments. At 502, flow 500 begins when a tier of aggregator computing devices receives data representing a request from a requester computing device. At 504, a subset of quoter computing devices is determined in a tier of quoter computing devices for purposes of generating one or more rate data components to support a final rate calculation. At 506, a rate algorithm type is identified at a quoter computing service. In some examples, an aggregator may access quoter configuration data stored in its local memory to receive this information. At 508, an in-memory cache is accessed to retrieve data representing rate algorithms and/or rate algorithm data associated with the rate algorithm type. Rate data components are calculated at 510 based on one or more request parameters and a rate algorithm associated with the rate algorithm type. At 512, one or more rate data components may be aggregated by an aggregator service to form an aggregated data structure with which to generate data representing a response to a request. Data representing a response may be generated at 514 to include data configured to cause presentation at a requester computing device. The data can cause presentation of a graphically-formatted representation of the response, which may include rate data for multiple property listings as a function of the underlying processes and structures described herein.

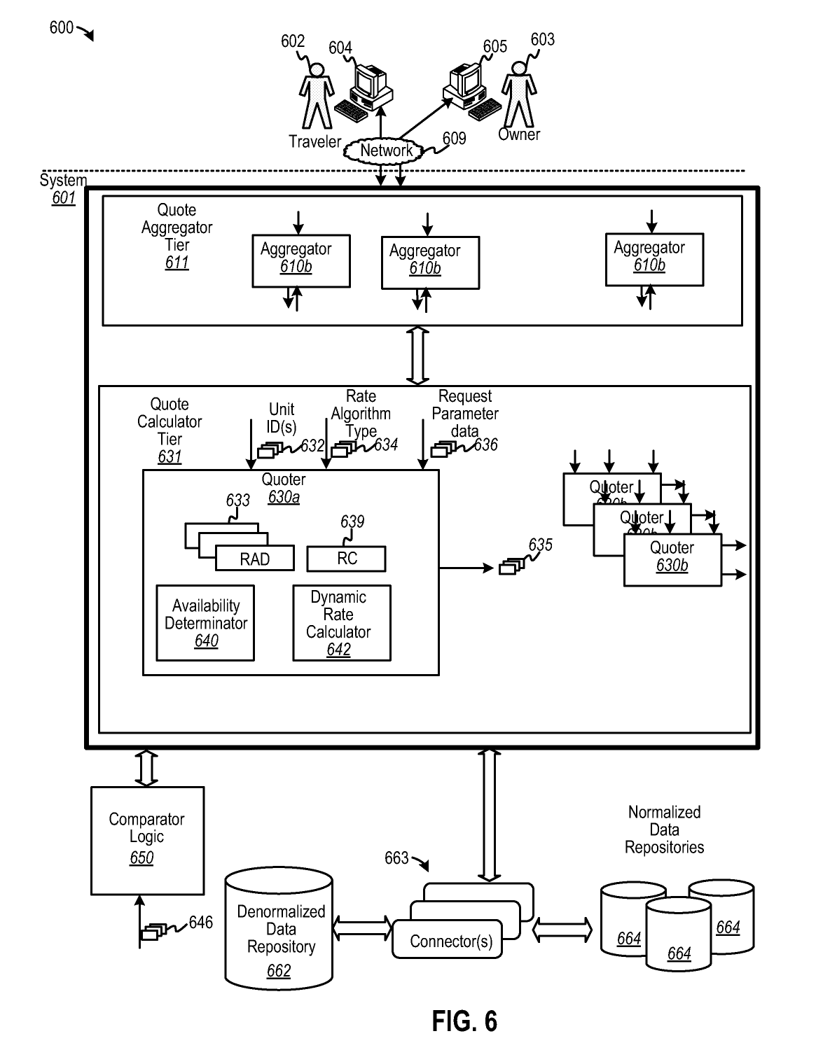

FIG. 6 is a diagram depicting another rate calculation system, according to some embodiments. Diagram 600 includes a rate calculation system 601 including a tier 611 (“quote aggregator tier”) of aggregator computing devices 610b and a tier 631 (“quote calculator tier”) of quoter computing devices 630a and 630b, whereby rate calculation system 601 is configured to access rate data instantaneously (or nearly instantaneously) for large numbers of properties subject to a search query. Tier 611 of aggregator computing devices is shown to include one or more aggregators 610b, each of which include one or more processors and memory and is configured to receive data representing a request via network 609 from a requester computing device 604 associated with a requester 602 (e.g., a traveler or potential renter). Note that an owner computing device 605 associated with owner 603 is also configured to access system 601 via network 609. Quoter 630a is shown to receive rental property unit identifier data (“Unit IDs”) 632, rate algorithm type data 634, request parameter data 636, and is further configured to generate rate data components 635. In addition, quoter 630a and/or any of its components, such as rate calculator 639, may be configured to access local memory to retrieve data representing rate algorithm data (“RAD”) 633 associated with a rate algorithm type data 634. According to some embodiments, the local memory can be implemented as a denormalized data arrangement within an in-memory cache of a quoter computing device 630a. Diagram 600 further depicts system 601 including a denormalized data repository 662, one or more connectors 663, and one or more normalized data repositories 664, which may be communicatively coupled together. Note that elements depicted in diagram 600 of FIG. 6 may include structures and/or functions as similarly-named or similarly-numbered elements depicted in other drawings.

Quoter 630a of FIG. 6 further includes availability determinator 640 and a dynamic rate calculator 642. Availability determinator 640 may be implemented in hardware and/or software, and includes logic for determining availability of a property associated with a property identifier by accessing calendar data stored in denormalized data arrangements in denormalized data repository 662 and/or in-memory cache implemented in any of quoters 630a and 630b. Availability data can be updated frequently (e.g., in real-time or nearly real-time) using cache refresh messaging described herein. Dynamic rate calculator 642 is configured to operate similar to rate calculator 639 and further includes algorithms for implementing availability data provided by availability determinator 640. Therefore, dynamic rate calculator 642 is configured to determine a unit's availability, and if it is not highly booked, the rate of the unit may be dynamically lowered correspondingly. By contrast, if a unit is in high demand, dynamic rate calculator 642 may increase the price accordingly.

FIG. 6 also depicts comparator logic 650 configured to receive rate data for a particular unit identifier associated with a property, and compare that rate data to other properties that are similarly-situated to determine whether the rate data of interest is priced lower or higher relative to other rate data structures. This information may be provided to owner 603 via owner computing device 605 so that owner 603 may adjust its property's rate structure to enhance revenue in the future. According to some embodiments, dynamic rate calculator 642 may include any number of algorithms or functionalities to implement dynamic pricing based on one or more other attributes or factors, such as the availability of local hotel rooms (i.e., adjacent, or within a proximity, to a property) and pricing trends, upcoming events in an area adjacent, or within a proximity to, the property, weather forecasts associated with the property, etc.

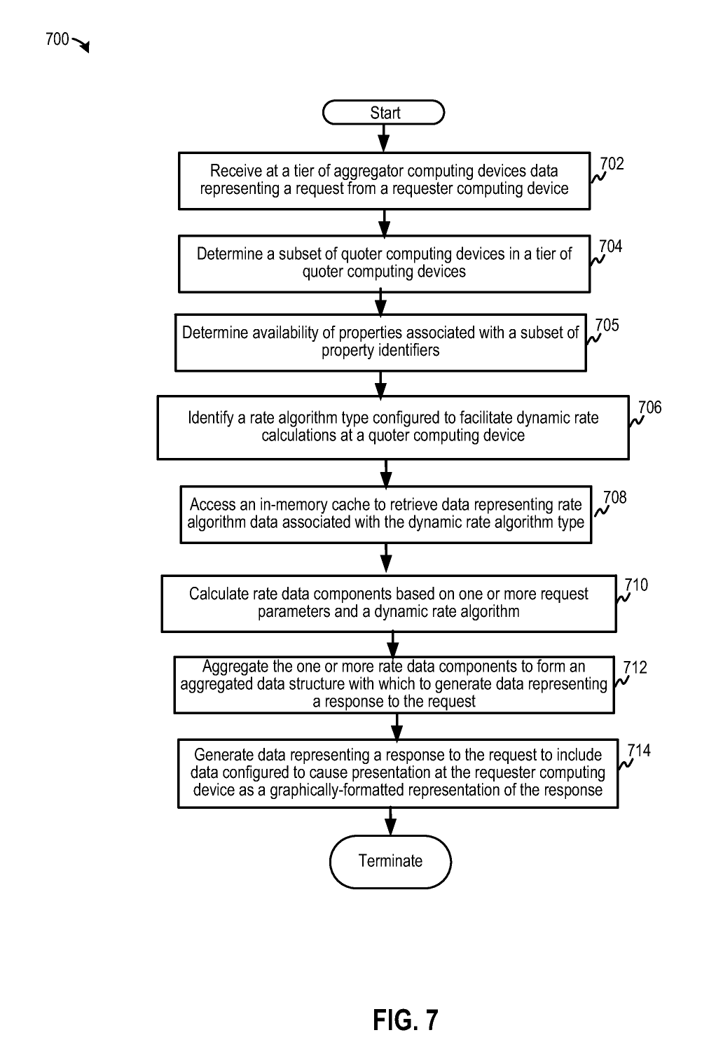

FIG. 7 is an example of a flow diagram to preform dynamic rate calculations, according to some embodiments. At 702, flow 700 begins when a tier of aggregator computing devices receives data representing a request from a requester computing device. At 704, a subset of quoter computing devices is determined in a tier of quoter computing devices for purposes of generating one or more rate data components to support a final rate calculation. At 705, availability of properties associated with a subset of property identifiers is determined. At 706, a rate algorithm type configured to facilitate dynamic rate calculations is identified at a quoter computing service. In some examples, an aggregator may access quoter configuration data stored in its local memory to receive this information. At 708, an in-memory cache is accessed to retrieve data representing a dynamic rate algorithm and/or its associated rate algorithm data. Rate data components are calculated at 710 based on one or more request parameters and a dynamic rate algorithm associated with the identified rate algorithm type that is configured to implement dynamic rate calculations. At 712, one or more rate data components may be aggregated by an aggregator service to form an aggregated data structure with which to generate data representing a response to a request. This data can be presented as a graphically-formatted representation of the response, which may include rate data for multiple property listings as a function of the underlying processes and structures described herein. At 714, data representing a response may be generated to include data configured to cause presentation at a requester computing device. The data can cause presentation of a graphically-formatted representation of the response, based on dynamically-calculated rate data for one or more property listings as a function of the underlying processes and structures described herein. In some examples, data generated at 714 is based on at least a portion of data determined by a dynamic rate calculator (e.g., dynamic rate calculator 642 of FIG. 6).

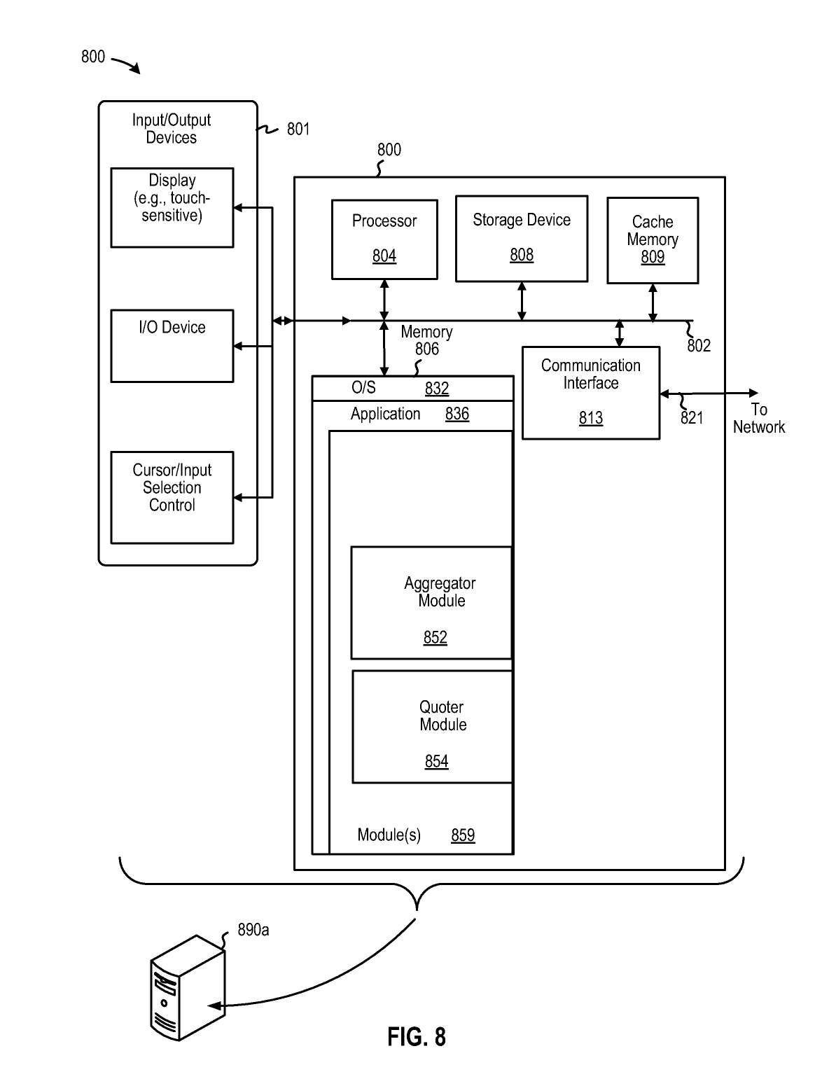

FIG. 8 illustrates an exemplary computing platform disposed in a computing system configured to calculate rates for items, such as rental properties, according to various embodiments. In some examples, computing platform 800 may be used to implement computer programs, applications, methods, processes, algorithms, or other software to perform the above-described techniques.

In some cases, computing platform 800 can be disposed in any device, such as a computing device 890a.

Computing platform 800 includes a bus 802 or other communication mechanism for communicating information, which interconnects subsystems and devices, such as processor 804, system memory 806 (e.g., RAM, etc.), storage device 808 (e.g., ROM, etc.), an in-memory cache 809 (which may be implemented in RAM 806 or other portions of computing platform 800), a communication interface 813 (e.g., an Ethernet or wireless controller, a Bluetooth controller, NFC logic, etc.) to facilitate communications via a port on communication link 821 to communicate, for example, with a computing device, including mobile computing and/or communication devices with processors. Processor 804 can be implemented with one or more central processing units (“CPUs”), such as those manufactured by Intel® Corporation, or one or more virtual processors, as well as any combination of CPUs and virtual processors. Computing platform 800 exchanges data representing inputs and outputs via input-and-output devices 801, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 800 performs specific operations by processor 804 executing one or more sequences of one or more instructions stored in system memory 806, and computing platform 800 can be implemented in a client-server arrangement, peer-to-peer arrangement, or as any mobile computing device, including smart phones and the like. Such instructions or data may be read into system memory 806 from another computer readable medium, such as storage device 808. In some examples, hard-wired circuitry may be used in place of or in combination with software instructions for implementation. Instructions may be embedded in software or firmware. The term “computer readable medium” refers to any tangible medium that participates in providing instructions to processor 804 for execution. Such a medium may take many forms, including but not limited to, non-volatile media and volatile media. Non-volatile media includes, for example, optical or magnetic disks and the like. Volatile media includes dynamic memory, such as system memory 806.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 802 for transmitting a computer data signal.

In some examples, execution of the sequences of instructions may be performed by computing platform 800. According to some examples, computing platform 800 can be coupled by communication link 821 (e.g., a wired network, such as LAN, PSTN, or any wireless network, including WiFi of various standards and protocols, Blue Tooth®, NFC, Zig-Bee, etc.) to any other processor to perform the sequence of instructions in coordination with (or asynchronous to) one another. Computing platform 800 may transmit and receive messages, data, and instructions, including program code (e.g., application code) through communication link 821 and communication interface 813. Received program code may be executed by processor 804 as it is received, and/or stored in memory 806 or other non-volatile storage for later execution.

In the example shown, system memory 806 can include various modules that include executable instructions to implement functionalities described herein. System memory 806 may include an operating system (“O/S”) 832, as well as an application 836 and/or logic module(s) 859. In the example shown, system memory 806 includes an aggregator module 852 and a quoter module 854, any of which, or one or more portions of which, can be configured to facilitate rate calculations in a distributed computing system by implementing one or more functions described herein.

In at least some examples, the structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” can refer, for example, to an algorithm or a portion thereof, and/or logic implemented in either hardware circuitry or software, or a combination thereof. These can be varied and are not limited to the examples or descriptions provided.

In some embodiments, aggregator module 852 and quoter module 854, or one or more of their components, or any process or device described herein, can be in communication (e.g., wired or wirelessly) with a mobile device, such as a mobile phone or computing device, or can be disposed therein.

In some cases, a mobile device, or any networked computing device (not shown) in communication with one or more modules 859 (e.g., aggregator module 852 and quoter module 854) or one or more of its components (or any process or device described herein), can provide at least some of the structures and/or functions of any of the features described herein. As depicted in the above-described figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figures can represent one or more algorithms. Or, at least one of the elements can represent a portion of logic including a portion of hardware configured to provide constituent structures and/or functionalities.

For example, aggregator module 852 and quoter module 854, or one or more of its components, or any process or device described herein, can be implemented in one or more computing devices (i.e., any mobile computing device, such as a wearable device, an audio device (such as headphones or a headset) or mobile phone, whether worn or carried) that include one or more processors configured to execute one or more algorithms in memory. Thus, at least some of the elements in the above-described figures can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit.

For example, aggregator module 852 and quoter module 854, or one or more of its components, or any process or device described herein, can be implemented in one or more computing devices that include one or more circuits. Thus, at least one of the elements in the above-described figures can represent one or more components of hardware. Or, at least one of the elements can represent a portion of logic including a portion of a circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method comprising:
receiving at a tier of aggregator computing devices data representing a request from a requester computing device, the request including rental property unit identifiers and one or more request parameters;
determining a subset of quoter computing devices in a tier of quoter computing devices as a function of a subset of the rental property unit identifiers;
identifying a rate algorithm type at a quoter computing device based on a rental property unit identifier;
accessing an in-memory cache to retrieve data representing rate algorithm data associated with the rate algorithm type;
calculating one or more rate data components based on the one or more request parameters and the rate algorithm;
aggregating the one or more rate data components to form an aggregated data structure with which to generate data representing a response to the request; and
generating data representing the response to the request to include data configured to cause presentation at the requester computing device as a graphically-formatted representation of the response.

2. The method of claim 1, wherein accessing the in-memory cache includes identifying the rate algorithm data.

3. The method of claim 2, wherein accessing the in-memory cache includes accessing a denormalized data arrangement.

4. The method of claim 2, wherein accessing the in-memory cache comprises:
applying address data to the in-memory cache,
wherein a processor associated with the quoter computing device applies the address data as an abbreviated form of the rental property unit identifier.

5. The method of claim 1, further comprising:
determining the rate algorithm data has changed; and
transmitting data representing an updated rate algorithm data to a group of in-memory caches associated with the subset of quoter computing devices.

6. The method of claim 5, further comprising:
updating the group of in-memory caches to include the updated rate algorithm data in a denormalized data arrangement.

7. The method of claim 6, wherein updating the group of in-memory caches is responsive to detecting a cache refresh message.

8. The method of claim 5, further comprising:
accessing sources of normalized data including one or more normalized databases that include rate data in a normalized data arrangement;
transforming the rate data into a denormalized data arrangement from the normalized data arrangement; and
storing the rate data in a denormalized database.

9. The method of claim 1, wherein receiving the data representing the request including one or more request parameters comprises:
receiving data representing a start date, and end date, and a number of occupants as the one or more request parameters.

10. The method of claim 1, wherein determining the subset of quoter computing devices comprises:
accessing quoter configuration data in an aggregator computing device.

11. The method of claim 10, wherein accessing the quoter configuration data comprises:
matching the address data against another in-memory cache associated with the aggregator computing device; and
retrieving the quoter configuration data specifying the subset of quoter computing devices.

12. The method of claim 10, further comprising:
partitioning data associated with the request into sub-requests; and
transmitting each of the sub-requests to a corresponding quoter computing device as indicated in the quoter configuration data.

13. The method of claim 12, wherein partitioning the data associated with the request into the sub-requests comprises:
partitioning the data based on one or more of different rate algorithm types, different shards, and different sub-request types.

14. The method of claim 10, further comprising:
determining the rate algorithm type;
transmitting data representing an updated rate algorithm type to one or more other in-memory caches disposed in the aggregator computing devices; and
refreshing the one or more other in-memory caches to include the updated rate algorithm type,
wherein the other in-memory caches include another memory cache.

15. The method of claim 1, further comprising:
determining availability of properties associated with the rental property unit identifiers.

16. The method of claim 15, wherein identifying the rate algorithm comprises:
identifying an associated rate algorithm configured to dynamical generate rates as a function of a rental property's availability.

17. A system comprising:
one or more aggregator computing devices including processors and memory configured to receive data representing a request from a requester computing device, the request including rental property unit identifiers and one or more request parameters, the one or more aggregator computing devices further configured to:
determine a subset of quoter computing devices in a tier of quoter computing devices as a function of a subset of the rental property unit identifiers,
aggregate one or more rate data components to form an aggregated data structure with which to generate data representing a response to the request, and
generate data representing the response to the request to include data configured to cause presentation at the requester computing device as a graphically-formatted representation of the response; and
one or more quoter computing devices including processors and memory configured to:
identify a rate algorithm type at a quoter computing device based on a rental property unit identifier,
access an in-memory cache to retrieve data representing rate algorithm data associated with the rate algorithm type, and
calculate the one or more rate data components based on the one or more request parameters and the rate algorithm.

18. The system of claim 17, wherein the in-memory cache includes a denormalized data arrangement.

19. The system of claim 18, wherein a processor associated with the quoter computing device is configured to apply address data as an abbreviated form of the rental property unit identifier.

20. The system of claim 17, wherein the rate algorithm is a dynamic rate algorithm.
